(19) United States
(12) Patent Application Publication
(10) Pub. No.: US 2025/0250119 A1
(43) Pub. Date: Aug. 7, 2025

(54) CONVEYOR SYSTEM

(71) Applicant: Magnetic Products, Inc., Highland, MI (US)

(72) Inventors: Ronald Kwasniewicz, Walled Lake, MI (US); Andrew Jackson, Brighton, MI (US)

(21) Appl. No.: 19/045,819

(22) Filed: Feb. 5, 2025

Related U.S. Application Data
(60) Provisional application No. 63/550,324, filed on Feb. 6, 2024.

(51) Int. Cl. B65G 23/24

(52) U.S. Cl. CPC B65G 23/24

(57) ABSTRACT

A conveyor system may include a foundation, a tray assembly moveably connected to and suspended from the foundation, a motor assembly configured to move the tray assembly relative to the foundation, and a conversion assembly connected to the motor assembly and to the tray assembly. The conversion assembly may be configured to convert rotary movement provided by the motor assembly into reciprocating movement of the tray assembly. The conversion assembly may include a transition plate and a connecting rod. The transition plate may be connected to the motor assembly and rotatable about a rotation axis via the motor assembly. The connecting rod may include a piston and a cylinder. The cylinder may be pivotably connected to a crank journal of the transition plate. The piston may include a piston rod connected to the tray assembly and a piston head adjustably arranged in a chamber of the cylinder.

### CROSS-REFERENCE TO RELATED APPLICATIONS

This application claims priority to U.S. Provisional Patent Application No. 63/550,324, filed on Feb. 6, 2024, the contents of which is hereby incorporated by reference in its entirety.

### TECHNICAL FIELD

The present disclosure generally relates to a conveyor system (e.g., an improved cradle conveyor system) for moving a variety of materials using kinetic energy and a method of moving and/or conveying materials, such as utilizing the aforementioned conveyor system.

### BACKGROUND

Conveyor systems are mechanical equipment used for moving products and materials from one location to another, typically in industrial environments. They are known to be used in businesses for handling items such as heavy equipment, mass-produced products, raw materials, and the like. A variety of industries use conveyor systems, resulting in an array of shapes, sizes, and operating systems depending on the requirements of a particular business.

One type of conveyor system is an oscillating conveyor, which may include reciprocating or vibrating/vibratory conveyors for example. Vibratory conveyors generally bounce material (e.g., a product) along a path on a conveying member, which may be in the shape of a trough. Such a system generates a vibratory force in the direction and angle of the desired path of the material on the conveying member. The material is physically lifted from the conveying member and pushed or moved forward due to the vibratory force.

However, traditional conveyor systems can be difficult to control. They may also exceed vibration speeds, which can result in the generation of undesirable (e.g., damaging and/or harmful) friction and/or the production of adverse stress on its components, which can in turn reduce and/or limit the service life of the conveyor system. Moreover, generally speaking, reciprocating and/or vibrating conveyors require regular maintenance due at least in part to the nature of the stress on the components of the conveyor system and the friction created by the drive mechanism of the conveyor system. The replacement or maintenance of a worn belt or other element in such a system, for example, may be costly and time consuming, and necessitate shutting down the conveyor system for an extended period of time.

Some conveyor systems use pneumatically controlled mechanisms or actuators to advance material along a transport tray on which the material is disposed. During operation of such systems, a pneumatic drive assembly drives the transport tray in a rectilinear fashion to advance materials along a length of the tray. Other conveyor systems utilize rotatable cams, cam followers, and a counterweight to produce the desired reciprocating movement. In these systems, the cam generates movement in one direction while the counterweight produces motion in the opposite direction.

Generally, conveyor systems operate on a principle that is based on the distinction between static friction and dynamic friction. Static friction coefficients are typically higher than dynamic friction coefficients. As such, when a body is in motion an object resting on the body tends to remain in place on the body until the static friction between the object and the body is overcome. Once the static friction is overcome (e.g., by abruptly halting and/or stopping the motion of the body), sliding of the object on, across, and/or along the body typically occurs due to the lower dynamic friction between the object and the body during motion of the object relative to the body. Conveyor systems may rely on complex mechanical devices that impart sudden forward and then reverse drives to generate the desired movement of the material, which can lead to wear, tear, breakage, and costly and time-consuming repairs. Costs are incurred not only because of the expense to repair the conveyor system, but also due to the downtime of the overall facility since product is unable to be moved throughout the facility and completed for sale.

Therefore, there is a need for an improved material conveying system that minimizes or eliminates one or more challenges or shortcomings of existing material conveying systems.

### SUMMARY

A conveyor system may include a foundation, a tray assembly moveably connected to and suspended from the foundation, a motor assembly configured to move the tray assembly relative to the foundation, and a conversion assembly connected to the motor assembly and to the tray assembly. The conversion assembly may be configured to convert rotary movement provided by the motor assembly into reciprocating movement of the tray assembly. The conversion assembly may include a transition plate and a connecting rod. The transition plate may be connected to the motor assembly and rotatable about a rotation axis via the motor assembly. The transition plate may include a crank journal arranged offset from the rotation axis. The connecting rod may be connected to the transition plate and to the tray assembly. The connecting rod may include a cylinder and a piston. The cylinder may be pivotably connected to the crank journal of the transition plate such that the cylinder translates in a circular motion around the rotation axis via rotation of the transition plate. The piston may include a piston rod and a piston head. The piston rod may be connected to the tray assembly. The piston head may be connected to the piston rod and adjustably arranged in a chamber of the cylinder.

A conveyor system may include a foundation, a tray assembly configured to receive and support material, a motor assembly configured to move the tray assembly relative to the foundation, and a conversion assembly connected to the motor assembly and to the tray assembly. The foundation may include a foundation frame, a plurality of strap connectors, and a frame bumper. The strap connectors may each include a hanger and a strap. The hanger may be connected to and project from the foundation frame. The strap may have a first end attached to the hanger and an opposite second end attached to the tray assembly such that the tray assembly is suspended from the hanger via the strap. The conversion assembly may be configured to convert rotary movement provided by the motor assembly into reciprocating movement of the tray assembly. The frame bumper may be connected to the foundation frame. The tray assembly may move into and out of contact with the frame bumper during the reciprocating movement of the tray assembly.

Various other features and advantages will be made apparent from the following detailed description and the drawings. For example, it will be apparent by the disclosure that the system and method disclosed could be used in various other contexts including with different input mechanisms, with different size conveyor systems, and with moving a variety of conveyed materials.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a perspective view of an exemplary cradle conveyor;

FIG. 2 is a perspective view of the exemplary cradle conveyor of FIG. 1 with the panel and diverters hidden;

FIG. 3 is a close-up perspective view of a strap connector of the exemplary cradle conveyor of FIG. 1;

FIG. 4 is a perspective view of a motor and a first adjustable mounting assembly of a drive assembly of the exemplary cradle conveyor of FIG. 1;

FIG. 5 is a perspective view of a conversion assembly and a second adjustable mounting assembly of the drive assembly of the exemplary cradle conveyor of FIG. 1;

FIG. 6 is a cross-sectional view of a connecting rod of the drive assembly of the exemplary cradle conveyor of FIG. 1;

FIG. 7 is a cross-sectional view of a foundation, a tray frame, and a connecting rod of the exemplary cradle conveyor of FIG. 1;

FIGS. 8A-8D are simplified schematic depictions of the foundation, the tray assembly, the conversion assembly, and the material during various steps of a method of operating the cradle conveyor of FIG. 1;

FIGS. 9A-9G are simplified schematic cross-sectional depictions of the connecting rod and the conversion assembly during the various method steps depicted in FIGS. 8A-8D;

FIGS. 10A-10D are simplified schematic depictions of the foundation, the tray assembly, the conversion assembly, and the material during various steps of a method of operating a second exemplary cradle conveyor; and

FIGS. 11A-11G are simplified schematic cross-sectional depictions of the connecting rod and the conversion assembly during the various method steps depicted in FIGS. 10A-10D.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

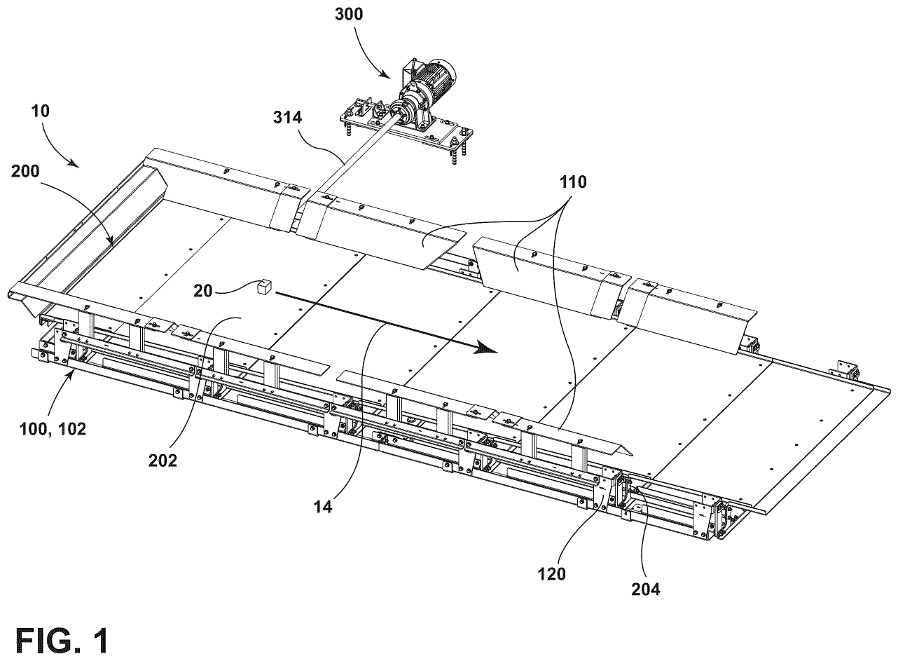

This disclosure relates generally to a cradle conveyor system 10 for moving material(s) 20, which is symbolically depicted as a simplified box in FIGS. 1, 8A-8D, and 10A-10D. An exemplary conveyor system 10 includes a foundation 100, a tray assembly 200, and a drive assembly 300. The tray 200 receives and supports the material 20, and the material 20 is moved along the tray assembly 200 to a certain location and/or destination (e.g., off an open end of the tray assembly 200 and into a container) via actuation of the drive assembly 300. In some examples, the material 20 is debris, scrap, and/or waste material that falls or is dropped onto the tray assembly 200 (e.g., as it is removed and/or cut off of an object, such as by a laser). The tray assembly 200 is movably and/or adjustably connected to and suspended from the foundation 100 via strap connectors 120. The tray assembly 200 is movable relative to the foundation 100 by the drive assembly 300, which includes a motor assembly 310 and a conversion assembly 600. The motor assembly 300 is connected to the tray assembly 200 via a connecting rod 618 of the conversion assembly 600, which converts rotational and/or rotary movement provided by the motor 312 into reciprocating (e.g., substantially linear) movement of the tray assembly 200. The connecting rod 618 includes a piston 660 and a cylinder 630. A piston rod 664 of the piston 660 is connected to the tray assembly 200 via a flexible belt 620. A piston head 662 of the piston 660 is slidably arranged in the cylinder 630. The cylinder 630 is connected to a transition plate 612 by a crank journal 614. The transition plate 612 is rotated by the motor 312, which causes the crank journal 614 and thus the cylinder 630 to translate in a circular motion (e.g., along a circular path) around a rotation axis 12 in a plane perpendicular to the rotation axis 12. The circular motion of the cylinder 630 moves the piston head 662 within the piston chamber 632 in a substantially linear manner, which moves (e.g., pulls and/or pushes) the tray assembly 200 away from the frame bumper 108 of the foundation 100 during a first stroke. The material 20 disposed on the tray assembly 200 remains stationary on the tray assembly 200 and moves away from the frame bumper 108 in conjunction with the tray assembly 200 during the first stroke. The motion of the cylinder 630 and the tray assembly 200 away from the frame bumper 108 (e.g., quickly and/or abruptly) stops at the end of the first stroke, and the cylinder 630 and tray assembly 200 begin moving back toward the frame bumper 108 at the start of the second stroke. However, the momentum of the material 20 causes the material 20 to continue moving away from the frame bumper 108 even after the first stroke has ended (i.e., after the cylinder 630 and tray assembly 200 have stopped moving away from the frame bumper 108 and started moving back toward the frame bumper 108). This, in turn, results in the material 20 being thrown and/or sliding forward along the tray assembly 200 (e.g., along a desired material movement path 14) in a direction away from the frame bumper 108 and toward a desired location and/or destination. During the ending portion and/or phase of the second stroke (e.g., once the tray assembly 200 has contacted the frame bumper 108) and during the beginning of the next first stroke, the tray assembly 200 remains relatively still and/or the position of the tray assembly 200 relative to the foundation 100 and/or the rotation axis 12 remains substantially the same despite the movement of the cylinder 630. During this momentary pause in the movement of the tray assembly 200 (which may be referred to as a gripping stage), the material 20 settles and/or comes to rest (or nearly to rest) on the tray assembly 200 (i.e., stops moving and/or sliding relative to the tray assembly 200) in a position that is farther from the frame bumper 108 than at the start of the previous first stroke and the tray assembly 200 ‘re-grips’ the material 20. In this way the material 20 is advanced along the desired movement path 14 (e.g. toward an open end of the tray assembly 200 opposite the frame bumper 108 and/or a desired location for the material 20). This two-stroke process/cycle continually repeats due to the rotation of the transition plate 612 and/or the driveshafts 314, 610, thereby advancing the material 20 along the desired movement path 14 toward a desired location and/or destination in a stepwise manner.

Referring to FIG. 1, a conveyor system and/or assembly (e.g., a cradle conveyor) 10 is depicted. The conveyor system and/or cradle conveyor 10 includes a foundation 100, a tray assembly 200, and a drive assembly 300. The foundation 100 is secured, connected, and/or mounted to the ground (e.g., a concrete slab) or other stable structure and/or surface. The tray assembly 200 is movably and/or adjustably connected to the foundation 100. The tray assembly 200 is connected to the drive assembly 300 and can be moved relative to the foundation 100 by the drive assembly 300.

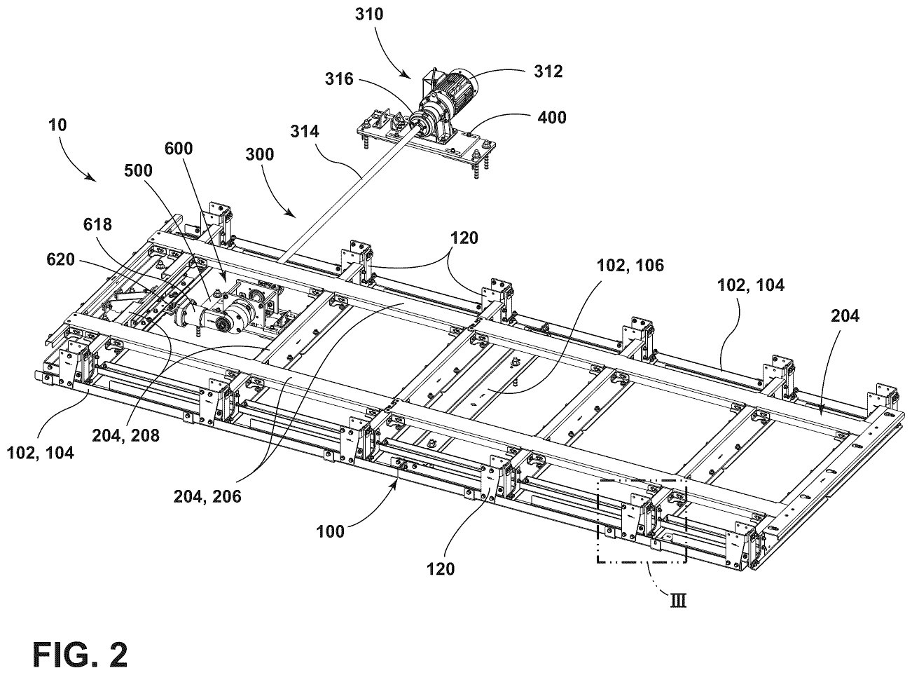

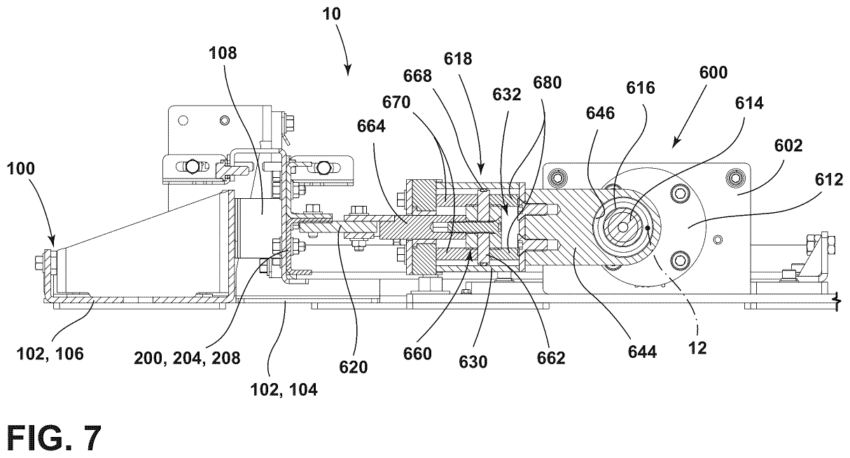

As generally illustrated in FIGS. 1 and 2, the foundation 100 includes a plurality of longitudinal members 104, a plurality of cross members 106, one or more frame bumpers 108 (see, e.g., FIG. 7), a plurality of diverters 110, and one or more strap connectors 120. The longitudinal members 104 and/or the cross members 106 may be beams, bars, rods, tubes, and/or other body. The members 104, 106 are typically metal, but may be composed of one or more other materials. The members 104, 106 are connected together to form and/or define a frame 102 (e.g., a foundation frame 102). The longitudinal members 104 are disposed spaced apart from one another and extend generally parallel to one another. The cross members 106 extend between and connect the longitudinal members 104 to one another. The frame bumper 108 is arranged on and connected to one or more of the cross members 106.

The frame bumper 108 is flexible and elastically deformable body (e.g., an elongated body), which may be composed of rubber and/or plastic (e.g., polyurethane) for example. The tray assembly 200 and/or tray frame 204 is moved into and out of contact with the frame bumper 108 during the reciprocating movement of the tray assembly 200 due to the circular motion of the crank journal 614 and/or the cylinder 630. The frame bumper 108 is deformed (e.g., compressed and decompressed) by the tray assembly 200 and/or tray frame 204 during operation to help slow, stop, and/or halt movement of the tray assembly 200 and/or tray frame 204 and to absorb impact forces of the tray assembly 200 and/or tray frame 204 (e.g., that may produce violent shock loads) when slowing and stopping movement of the tray assembly 200 and/or tray frame 204.

The diverters 110 are elongated plates and/or panels that cover, shield, and/or protect the strap connectors 120 (e.g., from falling material 20) and direct and/or guide falling material 20 toward and/or onto the panel 202 of the tray assembly 200. The diverters 110 are connected to the longitudinal members 104 of the foundation frame 102 (e.g., via one or more support members connected to and/or mounted on the hangers 122 of the strap connectors 120). The diverters 110 are disposed at least partially above one or more of the strap connectors 120 and partially above the tray assembly 200 (e.g., the panel 202). The diverters 110 are sloped and/or oriented at a downward angle toward the tray assembly 200 and/or panel 202 (e.g., extend transversely to the panel 202) to direct and/or guide falling material 20 that contacts and/or lands on the diverters 110 toward and/or onto the panel 202 of the tray assembly 200, where it can then be moved along the desired movement path 14 (e.g., toward an end of the tray assembly 200 and into a container).

The strap connectors 120 adjustably and/or movably connect the tray assembly 200 to the foundation 100 and/or the foundation frame 102. The strap connectors 120 are disposed on and connected to the longitudinal members of the foundation frame 102. A first subset of the strap connectors 120 are arranged spaced apart from one another along the first longitudinal member of the foundation frame 102 and a second subset of the strap connectors 120 are arranged spaced apart from one another along the second longitudinal member of the foundation frame 102.

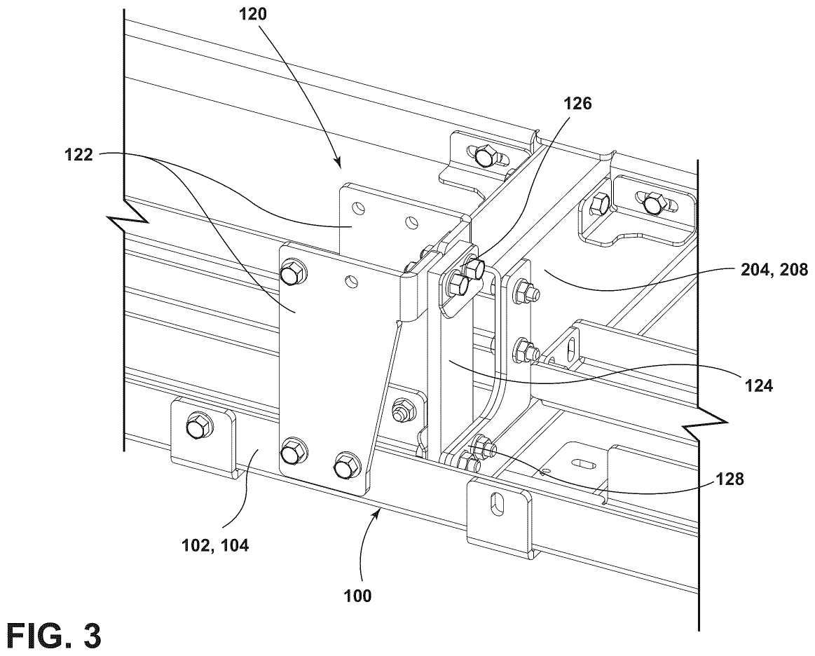

A strap connector 120, which is representative of each of the strap connectors 120 of the foundation 100, is depicted in FIG. 3. The strap connector 120 includes a hanger 122 and a strap 124. The hanger 122 is connected to and projects transversely (e.g., perpendicularly) from a longitudinal member 104 of the foundation frame 102, generally in a direction opposite gravity. The strap 124 is a multi-ply material and/or belt that is flexible (at least to an extent), strong, and durable. A first end of the strap 124 is attached and/or connected (e.g., fixed) to the hanger 122 at a strap-hanger connection point 126. A second, opposite end of the strap 124 is attached and/or connected (e.g., fixed) to the tray assembly 200 (e.g., a cross member 106 of the tray frame 204) at a strap-tray connection point 128. As such, the tray assembly 200 is suspended and/or hangs from the hangers 122 of the strap connectors 120 and is suspended above the ground and/or at least a portion of the foundation frame 102 via the straps 124 of the strap connectors 120.

As generally illustrated in FIGS. 1 and 2, the tray assembly 200 includes one or more panels 202 and a frame 204 (i.e., a tray frame 204). The panel 202 is disposed on, supported by, and connected to the tray frame 204. The tray assembly 200 and/or the panel 202 receives and supports the materials 20 that are moved by the conveyor system 10. In some examples, the material 20 is debris, scrap, and/or waste material that falls or is dropped onto the tray assembly 200 and/or panel 202 (e.g., as it is removed and/or cut off of an object, such as by a laser). The tray frame 204 includes a plurality of longitudinal members 206 and a plurality of cross members 208. The longitudinal members 206 and/or the cross members 208 may be beams, bars, rods, tubes, and/or other body. The members 206, 208 are typically metal, but may be composed of one or more other materials. The members 206, 208 are connected together to form and/or define the tray frame 204. The longitudinal members 206 are disposed spaced apart from one another and extend generally parallel to one another. The cross members 208 extend between and connect the longitudinal members 206 to one another. Each end of each cross member 208 is connected to the strap 124 of a respective strap connector 120 and, thereby, connected to the foundation 100 (e.g., the longitudinal members 104 of the foundation frame 102) via the plurality of strap connectors 120.

As generally illustrated in FIGS. 2, 4, and 5, the drive assembly 300 includes a plurality of subassemblies, including a motor assembly 310, a plurality of adjustable mounting assemblies 400, 500, and a conversion assembly 600. The motor assembly 310 is secured, connected, and/or mounted to the ground (e.g., a concrete slab) or other stable structure and/or surface by a first adjustable mounting assembly 400. The conversion assembly 600 is secured, connected, and/or mounted to the ground (e.g., a concrete slab) or other stable structure and/or surface by a second adjustable mounting assembly 500.

The motor assembly 310, which is a subassembly of the drive assembly 300, includes a motor 312, a motor driveshaft 314, and a plurality of couplers 316, 318. The motor 312 is secured, connected, and/or mounted on the slider plate 404 of the first adjustable mounting assembly 400 and, in this way, connected and/or secured to the ground. The motor driveshaft 314 extends between and operatively connects the motor 312 and the conversion assembly 600 to one another. The motor driveshaft 314 is connected to the motor 312 by a first coupler 316 and is connected to the conversion assembly 600 by a second coupler 318. The couplers 316, 318 are tire couplers 316, 318 in the illustrative example depicted herein, but one or more other types of couplers and/or connections are conceivable. When operated, the motor 312 rotates the motor driveshaft 314 and the conversion assembly 600 converts the rotary motion of the motor driveshaft 314 into substantially linear motion (e.g., reciprocating linear motion of the piston 660).

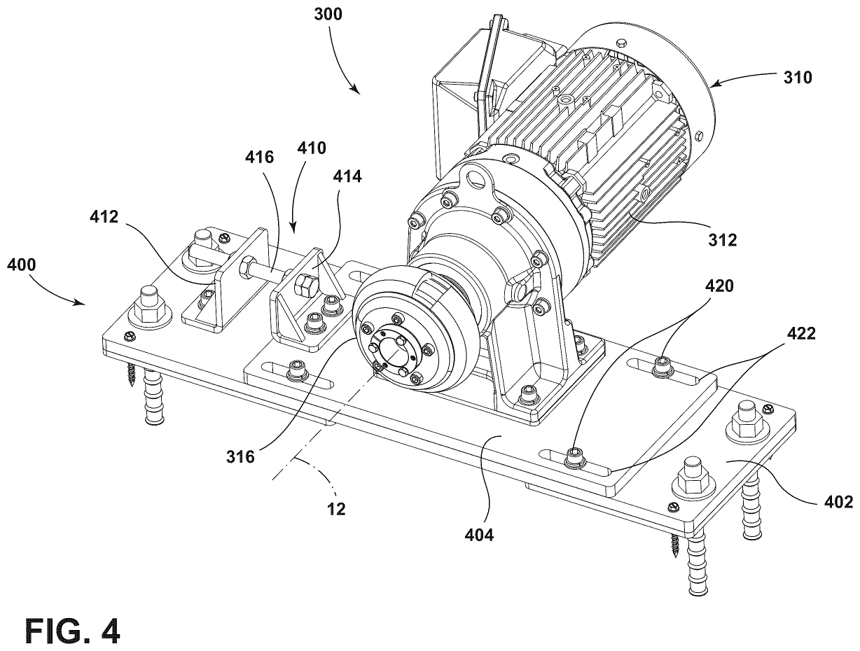

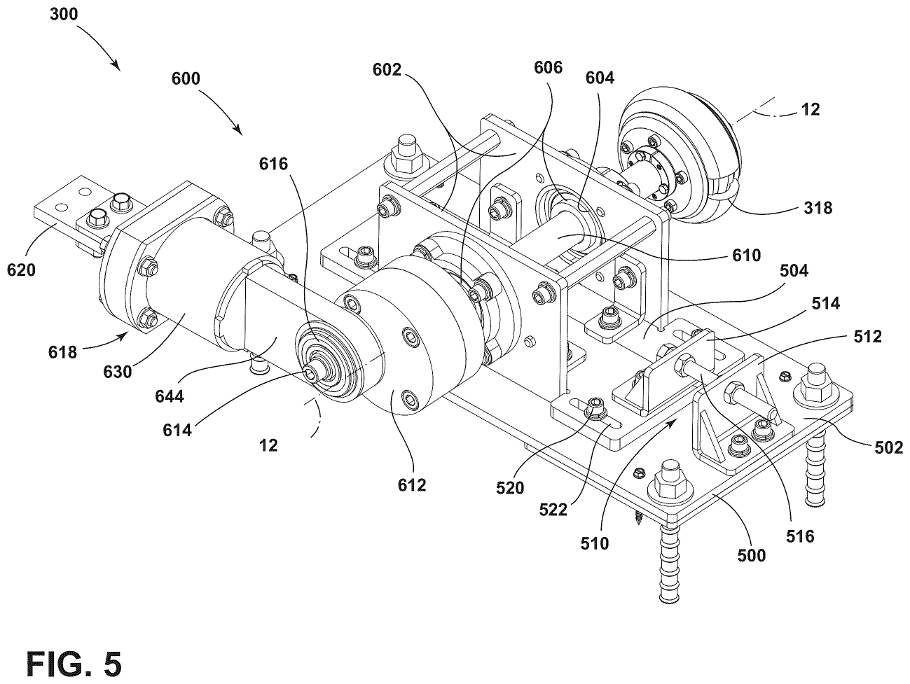

As generally illustrated in FIGS. 4 and 5, each adjustable mounting assembly 400, 500 includes a mount plate 402, 502, a slider plate 404, 504, and an adjustor 410, 510 configured to move and/or adjust the slider plate 404, 504 relative to the mount plate 402, 502. The mount plate 402, 502 is secured, connected, and/or mounted to the ground (e.g., a concrete slab) or other stable supporting structure and/or surface, such as via bolts or other fasteners. The slider plate 404, 504 is movably and/or adjustably (e.g., slidably) connected to the mount plate 402, 502, such as via one or more members 420, 520 (e.g., pins, bolts, etc.) connected to and/or engaged with the mount plate 402, 502 that are slidably arranged in slots 422, 522 disposed in and defined by the slider plate 404, 504. In the illustrative example herein, the adjustor 410, 510 includes a plurality and/or a pair of adjustment brackets (e.g., a mount bracket 412, 512 and a slider bracket 414, 514) and an adjustment bolt 416, 516. One of the adjustment brackets 412, 512 (e.g., the mount bracket 412, 512) is connected to the mount plate 402, 502. The other adjustment bracket 414, 514 (e.g., the slider bracket 414, 514) is connected to the slider plate 404, 504. The adjustment bolt 416, 516 extends between and engages the pair of adjustment brackets 412, 414, 512, 514. Rotation of the adjustment bolt 416, 516 in a first direction moves and/or draws the slider bracket 414, 514 toward the mount bracket 412, 512, which adjusts the slider plate 404, 504 toward the mount bracket 412, 512. Rotation of the adjustment bolt 416, 516 in a second opposite direction moves and/or pushes the slider bracket 414, 514 away from the mount bracket 412, 512, which adjusts the slider plate 404, 504 away from the mount bracket 412, 512. At least a portion of the motor assembly 310 (e.g., the motor 312) is secured, connected, and/or mounted on the slider plate 404 of the first adjustable mounting assembly 400. At least a portion of the conversion assembly 600 (e.g., the bearing plates 602) is secured, connected, and/or mounted on the slider plate 504 of the second adjustable mounting assembly 500. As such, the motor 312 and the conversion assembly 600 are each movable relative to the mount plate 402, 502 of their respective mounting assembly 400, 500. The mounting assemblies 400, 500 are arranged spaced apart from one another (e.g., in a direction extending parallel to the rotation axis 12) and are oriented relative to one another such that the slider plates 404, 504 are moveable and/or adjustable parallelly to one another (e.g., in a direction extending perpendicular to the rotation axis 12 and/or parallel to the central longitudinal axes of the adjustment bolts 416, 516). This enables the motor 312 and the conversion assembly 600 to each be adjusted relative to one another in a forward and backward direction, which simplifies and/or makes it easier to align the motor 312 and the conversion assembly 600 with one another when installing the motor driveshaft 314 and/or couplers 316, 318.

As generally illustrated in FIG. 5, the conversion assembly 600 includes a plurality of bearing plates 602, a plurality of bearings 606, 616, a converter driveshaft 610, one or more transition plates 612, a crank journal 614, a connecting rod 618, and a belt 620. The bearing plates 602 are connected to and project from the slider plate 504 of the second adjustable mounting assembly 500. The bearing plates 602 each include and/or define a bearing receptacle 604 in which a respective shaft bearing 606 is arranged. The converter driveshaft 610 extends through and is rotatably supported by the shaft bearings 606. A first end of the converter driveshaft 610 is connected, attached, and/or coupled to an end of the motor driveshaft 314, such as via the second tire coupler 318. The converter driveshaft 610 and the motor driveshaft 314 extend parallel to one another and are arranged coaxially. A second opposite end of the converter driveshaft 610 is connected to the transition plate 612. As such, operation of the motor 312 rotates the motor driveshaft 314, the converter driveshaft 610, and the transition plate 612 about a common rotation axis 12. The crank journal 614 is connected to and projects from the transition plate 612 (e.g., in a direction parallel to the driveshafts 314, 610). The crank journal 614 is a body, member, rod, and/or shaft (e.g., a driveshaft). The crank journal 614 is arranged near and/or adjacent to an outer perimeter and/or edge of the transition plate 612. The crank journal 614 is also disposed radially offset from the rotation axis 12 of the driveshafts 314, 610 and the transition plate 612. As such, rotation of the transition plate 612 creates a circular translational motion of the crank journal 614 (i.e., the crank journal 614 translates within a plane perpendicular to the rotation axis 12 along a circular path that extends around the rotation axis 12). A first end of the connecting rod 618 (e.g., the cylinder 630) is rotatably connected to and/or mounted on the crank journal 614 (e.g., via a crank bearing 616). A second opposite end of the connecting rod 618 (e.g., the piston 660 and/or piston rod 664) is connected to the belt 620, which is connected to the tray frame 204 (e.g., one of the cross members 208). In other words, the belt 620 extends between and connects the second end of the connecting rod 618 (e.g., the first end of the piston rod 664) and the tray frame 204 to one another. The belt 620 is a multi-ply material and/or strap that is flexible (at least to an extent), strong, and durable. The belt 620 is flexible and/or elastically deformable and, thereby, enables the orientation and/or angle of the connecting rod 618 relative to the tray assembly 200 (e.g., the tray frame 204 and/or the cross member 208 to which the belt 620 is connected) to change and/or vary during operation.

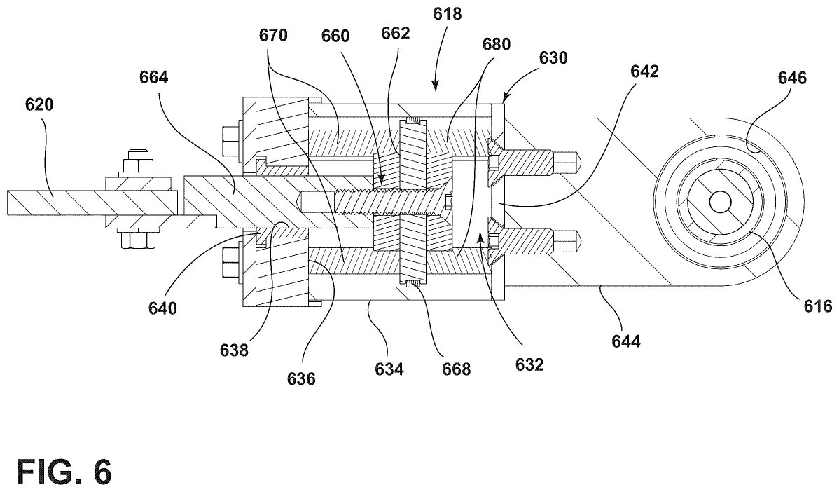

As generally illustrated in FIGS. 5-7, the connecting rod 618 includes a cylinder 630 and a piston 660. The cylinder 630 includes a cylindrical wall 634, a first end wall 636, and a second end wall 642, which collectively define a piston chamber 632. The first end wall 636 and the second end wall 642 are disposed at and connected to opposite axial ends of the cylindrical wall 634. The first end wall 636 includes and/or defines a rod opening 638 that receives and retains a lubrication bearing 640, which slidably engages and supports a portion of the piston 660 (e.g., the piston rod 664). The first end wall 636 is disposed at and/or defines an open end of the cylinder 630, while the second end wall 642 is disposed at and/or defines an opposite closed end of the cylinder 630. A flange 644 is connected to and projects from the second end wall 642 and/or the closed end of the cylinder 630. The flange 644 includes and/or defines a recess 646 that receives and rotatably engages the crank journal 614 and, optionally, the crank bearing 616.

As generally illustrated in FIGS. 5-7, the piston 660 includes a piston head 662, a piston rod 664, and a piston ring 668. A first end of the piston rod 664 is connected to the belt 620. A second opposite end of the piston rod 664 is connected to the piston head 662. The piston rod 664 extends between and connects the belt 620 and the piston head 662. The piston rod 664 is disposed partially in and extends through the lubrication bearing 640 and the rod opening 638 of the cylinder 630 (e.g., the first end wall 636 thereof). The piston head 662 and the piston ring 668 are adjustably and slidably arranged within the chamber 632 of the cylinder 630. The piston ring 668 (e.g., a PTFE wear ring) is disposed on, connected to, and extends around an outer circumferential surface of the piston head 662. The piston ring 668 contacts and slides along the inner surface of the cylindrical wall 634. In this manner, the piston ring 668 helps to maintain alignment of the piston 660 and the cylinder 630, in addition to supporting the piston head 662 within the chamber 632.

The piston 660 further includes a plurality of piston bumpers 670, 680 that are disposed in the chamber 632 of the cylinder 630. A first piston bumper 670 is disposed between the first end wall 636 of the cylinder 630 and a first axial end and/or end face of the piston head 662 that faces the first end wall 636 of the cylinder 630. A second piston bumper 680 is disposed between the second end wall 642 of the cylinder 630 and a second axial end and/or end face of the piston head 662 that faces the second end wall 642 of the cylinder 630. As such, the piston bumpers 670, 680 are disposed on opposite axial sides of the piston head 662. The piston bumpers 670, 680 are connected to and/or mounted on the piston head 662, and move within the chamber 632 in conjunction with the piston head 662. The first piston bumper 670 is arranged on and connected to the first axial end of the piston head 662. The second piston bumper 680 is arranged on and connected to the second axial end of the piston head 662. Alternatively, (i) the cylinder 630 includes the piston bumpers 670, 680 and the first and second piston bumpers 670, 680 are arranged on and connected to the first and second end walls 636, 642 of the cylinder 630, respectively, or (ii) the connecting rod 618 includes the piston bumpers 670, 680 and the piston bumpers 670, 680 are floatingly arranged in the chamber 632 (i.e., the piston bumpers 670, 680 are not fixed or secured to the cylinder 630 nor the piston head 662) on opposite axial sides of the piston head 662. The piston bumpers 670, 680 are flexible and elastically deformable tube-shaped and/or ring-shaped (i.e., annular) bodies, which may be composed of rubber and/or plastic (e.g., polyurethane) for example, e.g., deformable piston bumpers 670, 680. The first and second piston bumpers 670, 680 move into and out of contact with the first and second end wall 636, 642 of the cylinder 630, respectively, due to the movement of the piston head 662 within the chamber 632. The piston bumpers 670, 680 are compressed and decompressed by the piston head 662 in an alternating manner during operation to absorb impact forces of the piston head 662 (e.g., that may produce violent shock loads). For example, compression of the first piston bumper 270 begins at or around the time that the second piston bumper 680 becomes completely decompressed and compression of the second piston bumper 280 begins at or around the time that the first piston bumper 670 becomes completely decompressed. This handoff of force absorption between the bumpers 270, 280 significantly reduces, mitigates, and/or eliminates the occurrence and/or intensity of violent shock loads during operation allowing for the substantially linear motion of the tray assembly 200 to be as smooth as possible.

A method of moving material 20 with the conveyor system 10 is described below. The method includes disposing material 20 on the tray assembly 200 in a first and/or initial position and operating the conveyor system 10 as described in detail below to move the material 20 from the first/initial position to another desired location and/or destination (e.g., to move the material 20 off an open end of the tray assembly 200 and/or panel 202, such as into a container). In some examples, the material 20 is debris, scrap, and/or waste material and the material 20 falls or is dropped onto and received by the tray assembly 200 (e.g., as it is removed and/or cut off of an object, such as by a laser). The falling material 20 lands on and/or comes to rest on the tray assembly 200 and/or the panel 202 in the first/initial position. At least some of the material 20 may contact and/or fall onto one or more of the diverters 110. The materials 20 may bounce off of and/or slide along the diverters 110 onto the tray assembly 200 and/or the panel 202. In other words, the method may include shielding the strap connectors 120 from falling material 20 with one or more diverters 110 and guiding and/or redirecting the falling material 20 onto the tray assembly 200 and/or the panel 202 via the one or more diverters 110. The conveyor system 10, drive assembly 300, and/or motor assembly 310 is typically operating/active while material 20 is being disposed on the tray assembly 200. For example, materials 20 may continuously and/or intermittently be disposed on (e.g., fall onto) the tray assembly 200 while the conveyor system 10 is operating (i.e., while the tray assembly 200 is moving in the reciprocating manner) and, thus, the conveyor system 10 continuously receives materials 20 and moves the materials 20 to the desired location and/or destination. Alternatively, the conveyor system 10, drive assembly 300, and/or motor assembly 310 may not be operating/inactive when material 20 is disposed on the tray assembly 200 and may be subsequently actuated/activated to move the material 20 to the desired location and/or destination before more material 20 is disposed on the tray assembly 200.

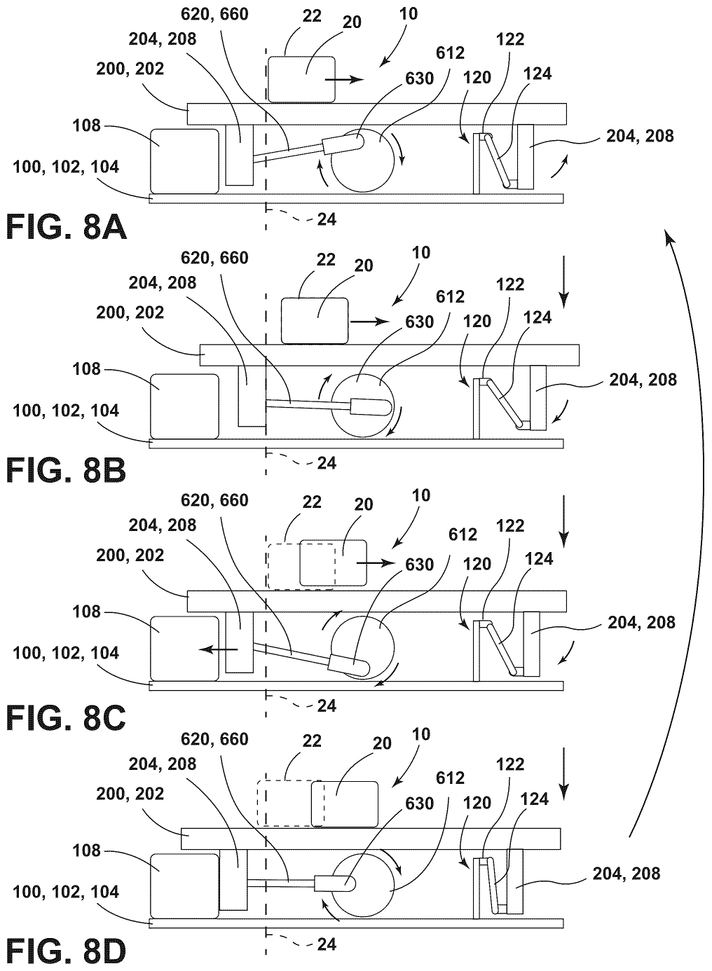

Operation of the conveyor system 10 and/or a method of operating the conveyor system 10 (e.g., to move material 20) is depicted in FIGS. 8A-8D. For positional reference purposes, a dashed-line box 22 representing a first or initial position of the material 20 on the tray assembly 200 and a dashed reference line 24 coinciding with an end of the material 20 when in the first position are depicted in FIGS. 8A-8D. The position of the dashed-line box 22 is fixed relative to the tray assembly 200 (i.e., the dashed-line box 22 moves in conjunction with the tray assembly 200, but does not move relative to the tray assembly 200 in the drawings) to more clearly illustrate the movement of the material 20 relative to the tray assembly 200. The position of the reference line 24 is fixed (i.e., the reference line 24 is in the same position relative to the frame bumper 108 in the drawings) to more clearly show the movement of the tray assembly 200 and the movement of the material 20 relative to the frame bumper 108 and/or the foundation 100.

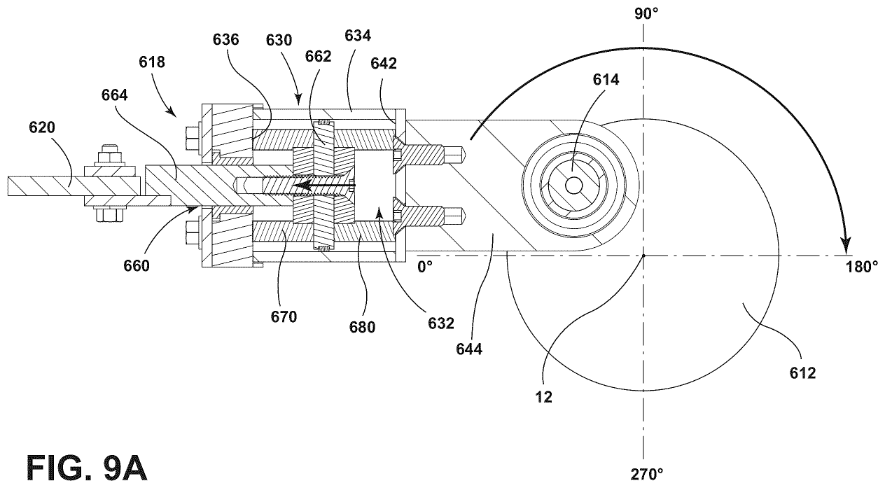

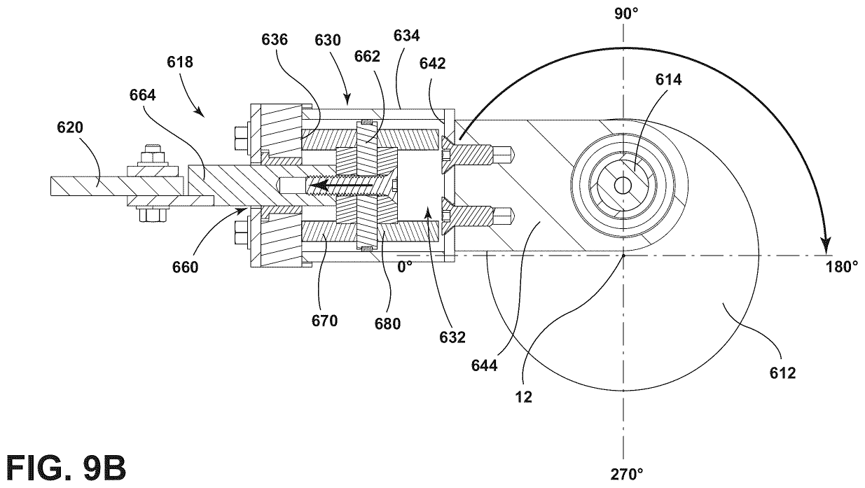

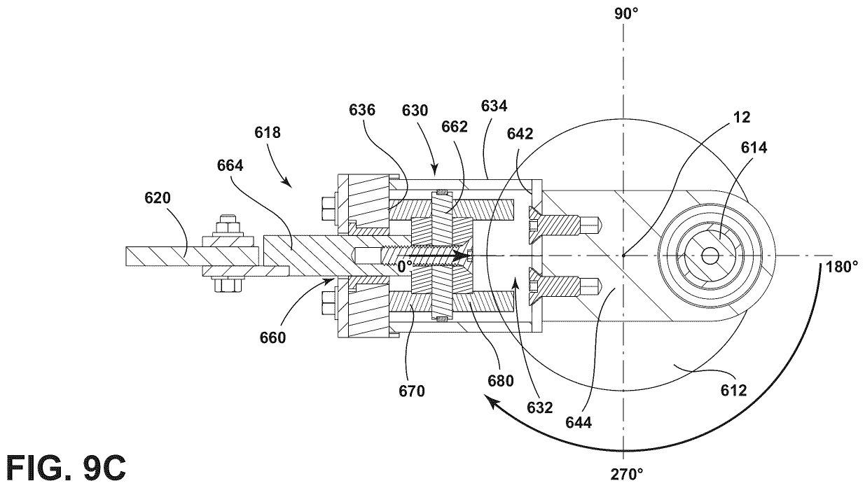

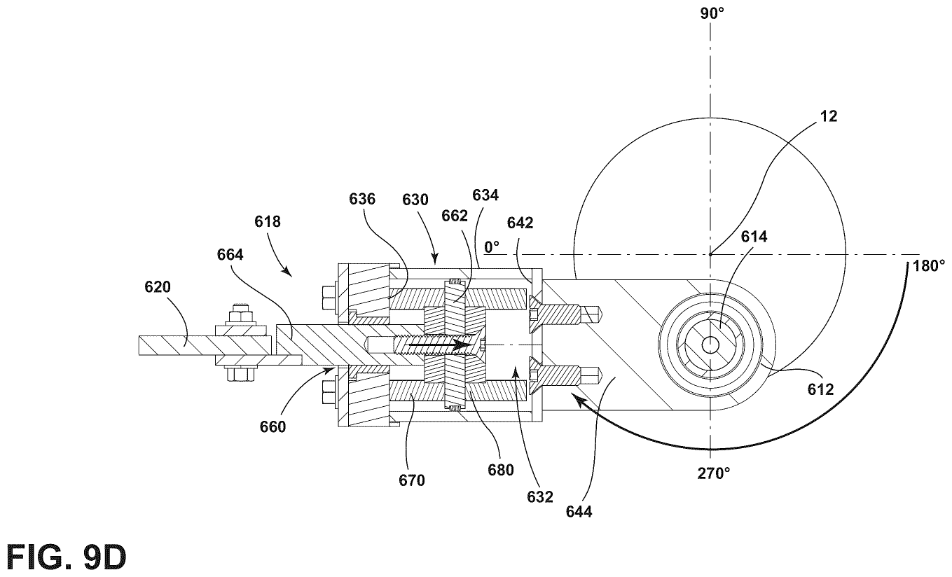

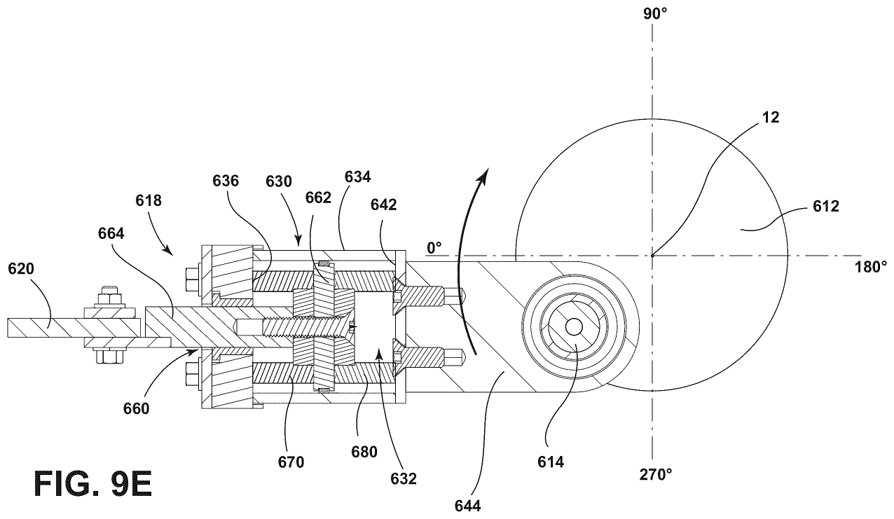

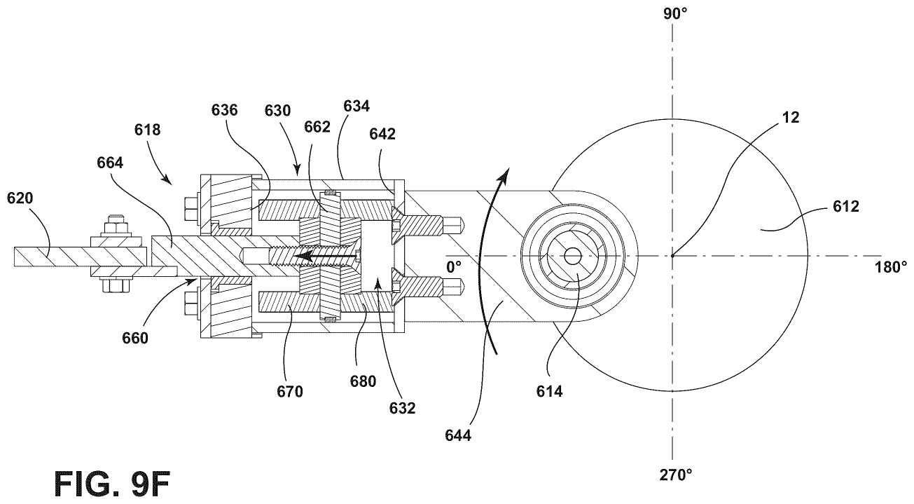

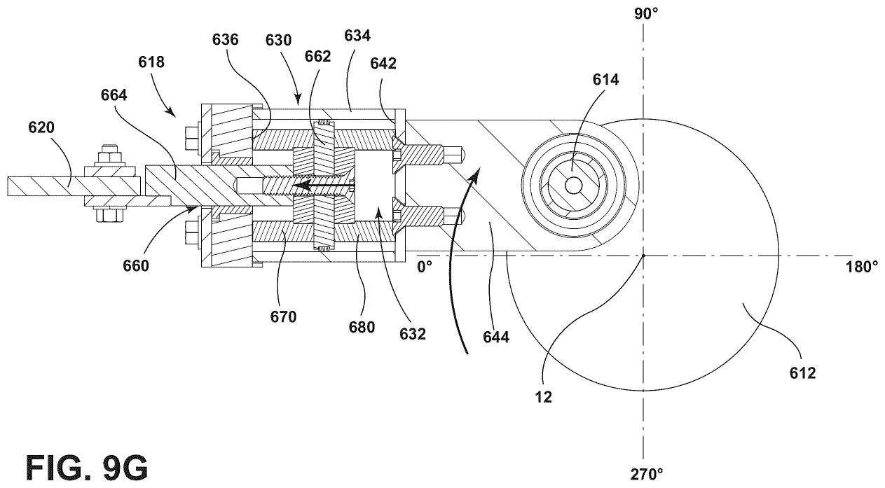

FIGS. 9A-9G are cross-sectional views depicting the position of the piston 660 within the chamber 632 during the steps depicted in FIGS. 8A-8D. For simplicity and ease of understanding, the rotational and/or pivoting motion of the cylinder 630 about the crank journal 614 that occurs during operation is not depicted in FIGS. 9A-9G.

During operation of the conveyor system 10, the motor 312 rotates the motor driveshaft 314 about the rotation axis 12, which rotates the converter driveshaft 610 about the rotation axis 12, which rotates the transition plate 612 about the rotation axis 12. The rotation of the transition plate 612 causes the crank journal 614, and thus the cylinder 630 (e.g., the connecting rod 618) connected thereto, to translate in a plane perpendicular to the rotation axis 12 in a circular motion (e.g., along a circular path) around the rotation axis 12 as shown in FIGS. 8A-9G and described in detail below. The cylinder 630 and/or the connecting rod 618 also rotates and pivots about the crank journal 614 during this translational movement as shown in FIGS. 8A-8D.

The connecting rod 618 moves and/or is adjusted in a two-stroke movement pattern as a result of the circular motion of the crank journal 614. The first stroke starts and the second stroke ends when the crank journal 614 is at or about a 0° position shown in FIGS. 8D and 9F. The first stroke ends and the second stroke starts when the crank journal 614 is at or about a 180° position shown in FIGS. 8B and 9C. The crank journal 614 rotates clockwise about the rotation axis 12 and/or the converter driveshaft 610. Thus, the positions shown in FIGS. 8A, 9A, 9B, and 9G occur during the first stroke and the positions shown in FIGS. 8C, 9D, and 9E occur during the second stroke. The 0° position and the 180° position at which there is a transition between strokes may be considered to occur during the first stroke, during the second stroke, or during both strokes (i.e., considered part of both the first and second stroke). The crank journal 614 and/or the cylinder 630 are disposed in (i) a 45° position in FIGS. 8A, 9A, and 9G, (ii) a 90° position in FIG. 9B, (iii) a 180° position in FIGS. 8B and 9C, (iv) a 270° position in FIGS. 8C and 9D, (v) a 315° position in FIG. 9E, and (vi) a 0° position in FIGS. 8D and 9F.

Starting at the 45° position of the crank journal 614 and/or cylinder 630 shown in FIGS. 8A and 9A, the first and second piston bumpers 670, 680 are in contact with the first and second end walls 636, 642 of the cylinder 630, respectively. The piston bumpers 670, 680 are not compressed, however. The material 20 is disposed on the tray assembly 200 and/or panel 202 in the first/initial position when the crank journal 614 and/or cylinder 630 are at the 45° position.

The crank journal 614 rotates clockwise from the 45° position (FIGS. 8A, 9A) toward the 180° position (FIGS. 8B, 9C), moving the cylinder 630 away from the frame bumper 108 via the flange 644. The motion of the cylinder 630 causes the first end wall 636 of the cylinder 630 to press the first piston bumper 670 into the piston head 662. This, in combination with the weight of the tray assembly 200, results in the piston head 662 moving and/or sliding in the piston chamber 632 toward the first end wall 636 of the cylinder 630, compressing the first piston bumper 670 and moving the second piston bumper 680 out of contact with the second end wall 642 of the cylinder 630. It also results in, simultaneously and/or subsequently, the cylinder 630 moving and/or pulling the piston head 662 away from the frame bumper 108 and/or toward the rotation axis 12 as shown in FIGS. 9A-9C, which in turn moves, pulls, and/or draws the tray assembly 200 away from the frame bumper 108 of the foundation 100 as shown in FIGS. 8A-8B. Since the tray assembly 200 hangs and/or is suspended from the hangers 122 of the strap connectors 120 by the straps 124, this movement of the tray assembly 200, at least to an extent, moves and/or pivots the straps 124 relative to their respective hanger 122 (e.g., moves the strap-tray connection points 128 about their respective strap-hanger connection points 126 in a circumferential direction) such that the strap-tray connection points 128 are laterally offset from the strap-hanger connection points 126 (i.e., the strap-tray connection points 128 and the strap-hanger connection points 126 are not aligned in a vertical direction and/or the direction of gravity) and the tray assembly 200 is raised and/or disposed farther away from the foundation frame 102 in the vertical direction. This movement may also cause flexing, bending, and/or elastic deformation of the straps 124. The material 20 remains stationary on the tray assembly 200 and/or the panel 202 and moves away from the frame bumper 108 in conjunction with the tray assembly 200 from the 45° position to the 180° position (e.g., due to static friction between the material 20 and tray assembly 200 and/or panel 202). In other words, the material 20 substantially remains on the tray assembly 200 in the first position 22 as the crank journal 614 and/or cylinder 630 move from the 45° position to the 180° position.

At the end of the first stroke (e.g., at the 180° position shown in FIGS. 8B and 9C), the motion of the cylinder 630 and the tray assembly 200 away from the frame bumper 108 (e.g., quickly and/or abruptly) stops. Additionally, the first piston bumper 670 is at its peak level of compression and the second piston bumper 680 is not compressed.

At the start of the second stroke, the crank journal 614 move clockwise from the 180° position (FIGS. 8B, 9C) toward the 0° position (FIGS. 8D, 9F) causing the cylinder 630 and tray assembly 200 to begin moving back toward the frame bumper 108 (e.g., as shown in FIGS. 8B-8D and 9C-9F). However, the inertia and/or momentum of the material 20, in addition to the reduction and/or elimination of static friction between the material 20 and the panel 202 achieved by the downward vertical motion of the tray assembly 200 during the second stroke, causes the material 20 to continue moving away from the frame bumper 108 during the second stroke (i.e., after the 180° position and/or after the tray assembly 200 has stopped moving away from the frame bumper 108). This, in turn, results in the material 20 being thrown forward, potentially becoming airborne (at least to a small degree), and sliding forward along the tray assembly 200 (e.g., along a desired material movement path 14) in a direction away from the frame bumper 108 at or about the transition from the first stroke to the second stroke (i.e., at or about the 180° position).

As the crank journal 614 moves from the 180° position toward the 315° position (i.e., during the second stroke), which is shown in FIGS. 8B-8C and 9C-9E, the cylinder 630 is moved back toward the frame bumper 108 by the clockwise movement of the crank journal 614. As the first end wall 636 of the cylinder 630 is moving away from the piston head 662, the piston head 662 and the second piston bumper 680 move within the chamber 632 toward the second end wall 642 of the cylinder 630 and the first piston bumper 670 decompresses. As a result, the suspended tray assembly 200 moves back toward the frame bumper 108 (e.g., swings from the hangers 122 back toward vertical alignment of the strap-tray connection points 128 and the strap-hanger connection points 126) and moves and/or drops closer to the foundation frame 102 in the vertical direction. The material 20 is still moving and/or sliding relative to the tray assembly 200 (e.g., in the direction away from the frame bumper 108), such as along a desired movement path 14, due to its inertia and/or momentum and the reduction of friction between the material 20 and the tray assembly 200 and/or the panel 202. The material 20 may also be airborne during at least a portion of this phase of the second stroke (e.g., as shown in FIG. 8C), which further facilitates movement of the tray assembly 200 in the opposite/reverse direction (i.e., back toward the frame bumper 108) without significantly impacting and/or influencing movement of the material 20 (e.g., without slowing forward movement of the material 20 and/or dragging the material 20 back toward the frame bumper 108 with it).

When the crank journal 614 reaches the 315° position shown in FIG. 9E, the second piston bumper 680 contacts the second end wall 642 of the cylinder 630. The first and second piston bumpers 670, 680 are in contact with the first and second end walls 636, 642 of the cylinder 630, respectively, but the piston bumpers 670, 680 are substantially uncompressed. The material 20 is also still moving and/or sliding relative to the tray assembly 200 (e.g., in the direction away from the frame bumper 108).

During the final portion and/or phase of the second stroke and during the beginning of the next first stroke (e.g., from the 315° position to the 45° position, which may be referred to as a gripping phase and is shown in FIGS. 9E-9G), the piston head 662 slides within the chamber 632, the frame bumper 108 compresses and decompresses, and the second piston bumper 680 compresses and decompresses. As such, despite the movement of the cylinder 630, the lateral distance between the piston head 662 and the rotation axis 12 remains relatively similar and/or changes only slightly (see, e.g., FIGS. 9E-9G). The tray assembly 200 therefore remains relatively still and/or the position of the tray assembly 200 relative to the foundation 100 and/or the rotation axis 12 remains substantially constant during the gripping phase. In other words, there is a momentary pause in the movement of the tray assembly 200 as the crank journal 614 moves from the 315° position (FIG. 9E) to the 45° position (FIG. 9G). During this momentarily pause in the movement of the tray assembly 200 (i.e., during the gripping phase), the material 20 stops moving and/or sliding relative to the tray assembly 200 and the material 20 settles and/or comes to rest (or nearly to rest) on the tray assembly 200 in a second or advanced position. The second position is farther from the frame bumper 108 and closer to a desired final location for the material 20 than the first position 22 at which the material 20 was located during the previous first stroke as shown in FIG. 8D. By coming to rest on the tray assembly 200 again, the tray assembly 200 and/or panel 202 ‘re-grips’ the material 20 (e.g., due to the presence of static friction) so that the material 20 will move in conjunction with the tray assembly 200 during the next first stroke.

As the crank journal 614 moves from the 315° position to the 0° position (see FIGS. 8C-8D and 9E-9F), the cylinder 630 is moved back toward the frame bumper 108 by the clockwise movement of the crank journal 614. The tray assembly 200 contacts and compresses the frame bumper 108, slowing and eventually stopping the movement of the tray assembly 200. There is relatively little change in the lateral distance between the tray assembly 200 and the frame bumper 108 and/or the rotation axis 12 during this phase. The slowing and/or stopping of the tray assembly 200 due to contacting the frame bumper 108 causes the piston head 662 to slide toward the second end wall 642 of the cylinder 630, which in turn compresses the second piston bumper 680 against the second end wall 642 of the cylinder 630 and moves the first piston bumper 670 out of contact with the first end wall 636 of the cylinder 630. The material 20 is still moving and/or sliding relative to the tray assembly 200 (e.g., in the direction away from the frame bumper 108) during this phase, but the movement and/or speed of the material 20 decreases and/or approaches zero (e.g., the material 20 begins coming to a stop).

When the crank journal 614 is at the 0° position (i.e., at the end of the second stroke and beginning of the next first stroke) shown in FIGS. 8D and 9F, the frame bumper 108 and the second piston bumper 680 are each at their respective peak level of compression and the first piston bumper 670 is not compressed. The position of the tray assembly 200 relative to the frame bumper 108 and/or the rotation axis 12 is similar to and/or only slightly different than when the crank journal 614 was at the 315° position. Additionally, at this time and/or position, movement of the material 20 has typically stopped and the material 20 has settled and/or come to rest (or nearly to rest) on the tray assembly 200 and/or panel 202 in the second position and has been ‘re-gripped’ by the tray assembly 200 and/or panel 202.

As the crank journal 614 moves from the 0° position to the 45° position as shown in FIGS. 9F-9G, the cylinder 630 begins moving away from the frame bumper 108 again due to the movement of the crank journal 614. The piston head 662 and the first piston bumper 670 move and/or slide in the chamber 632 toward the first end wall 636 of the cylinder 630 and the second piston bumper 680 decompresses. The frame bumper 108 decompresses, moving the tray assembly 200 slightly toward the rotation axis 12 and, optionally, out of contact with the frame bumper 108 (see FIG. 8A). Nevertheless, there is relatively little change in the distance between the tray assembly 200 and the rotation axis 12 during this movement phase due at least in part to the simultaneous decompression of the second piston bumper 680 (see, e.g., FIGS. 9F-9G). If movement of the material 20 did not already completely stopped and/or the material 20 did not already come completely to rest on the tray assembly 200, the material 20 settles and comes to rest on the tray assembly 200 and/or panel 202 in the second position and is ‘re-gripped’ by the tray assembly 200 and/or panel 202.

As shown in FIG. 9G, at the 45° position of the next first stroke, the first and second piston bumpers 670, 680 are in contact with the first and second end walls 636, 642 of the cylinder 630, respectively, but are not compressed. The material 20 is disposed on the tray assembly 200 in the second position and, thus, farther from the frame bumper 108 and/or closer to the desired final location than during the previous first stroke (e.g., when the crank journal 614 was at the 45° position shown in FIG. 9A and the material 20 was disposed in the first position). Since the tray assembly 200 ‘re-griped’ the material 20 during the momentary pause in the movement of the tray assembly 200 (e.g., during the gripping phase between the 315° position and the 45° position), the material 20 remains stationary on the tray assembly 200 (i.e., in the second position) as the crank journal 614 rotates clockwise from the 45° position toward the 180° position again and the previously described movements/processes repeat. The material 20 is thereby advanced along the tray assembly 200 from the second position to a third position that is farther from the frame bumper 108 (e.g., closer to the desired final location) than the second position and the first position. This two-stroke process/cycle continually repeats due to the rotation of the transition plate 612 and/or the driveshafts 314, 610, thereby advancing the material 20 along the desired movement path 14 in a stepwise manner to the desired final location.

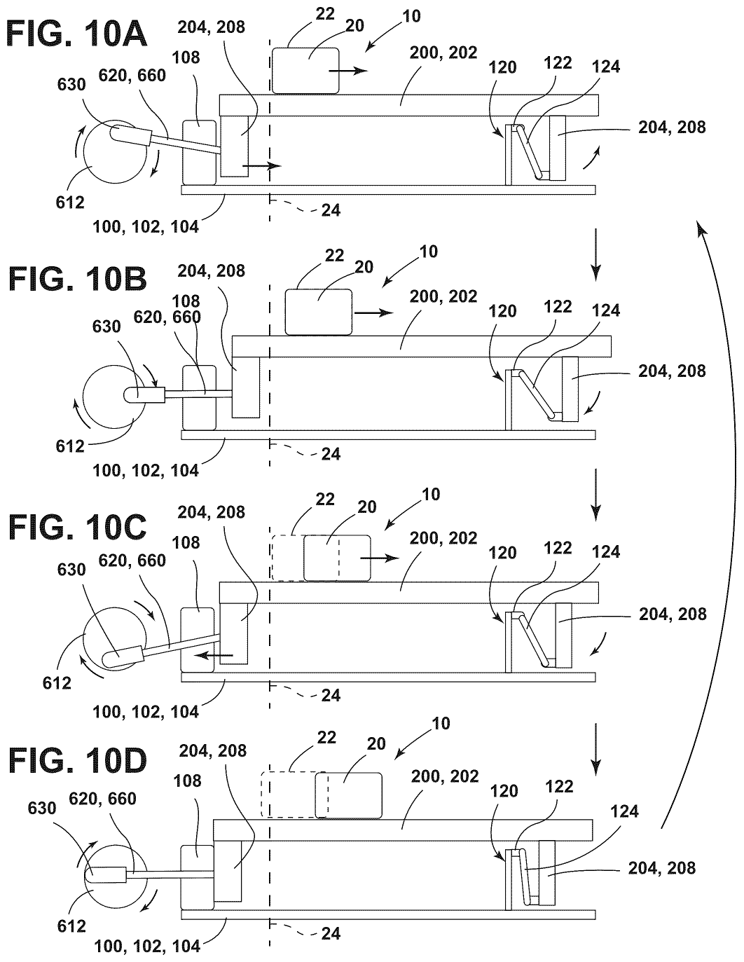

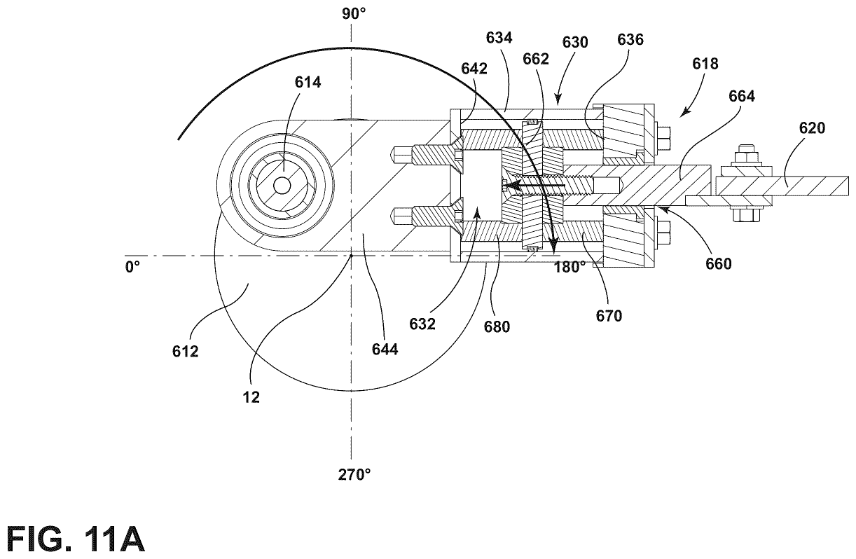

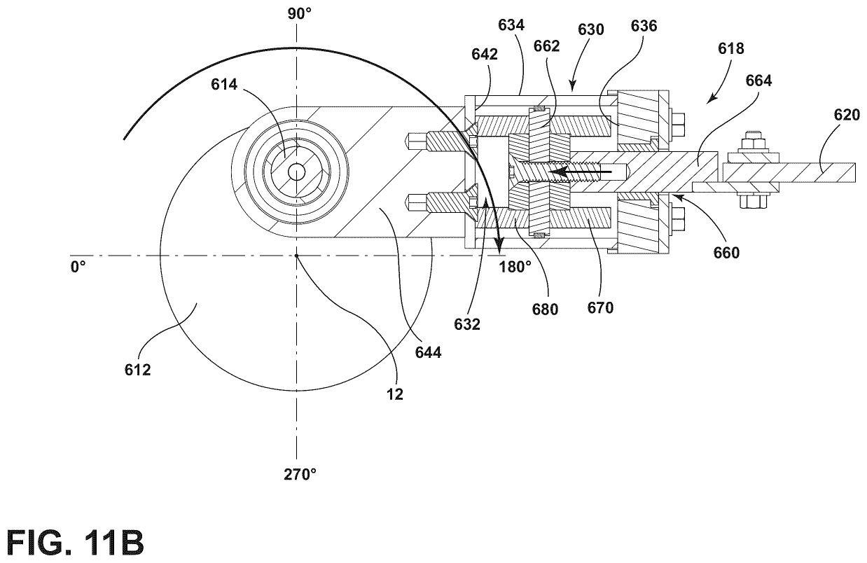

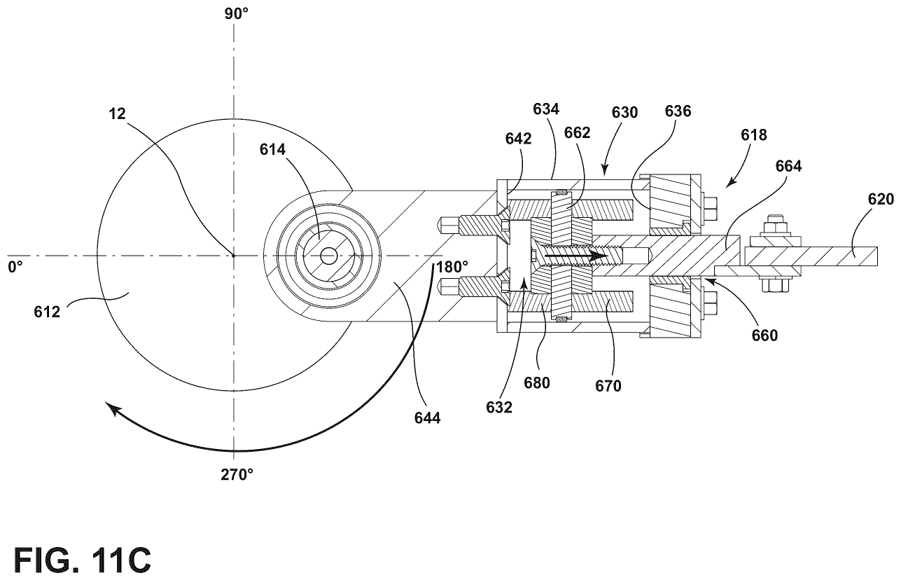

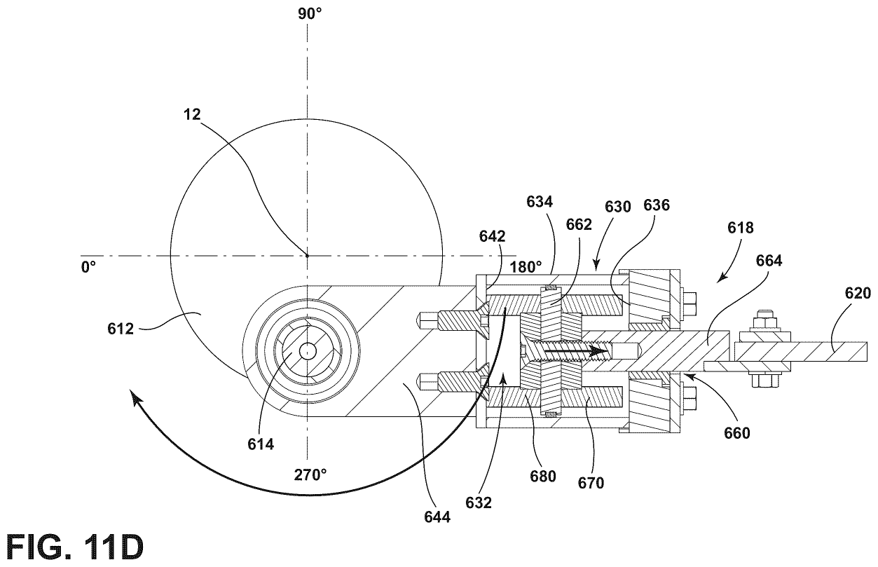

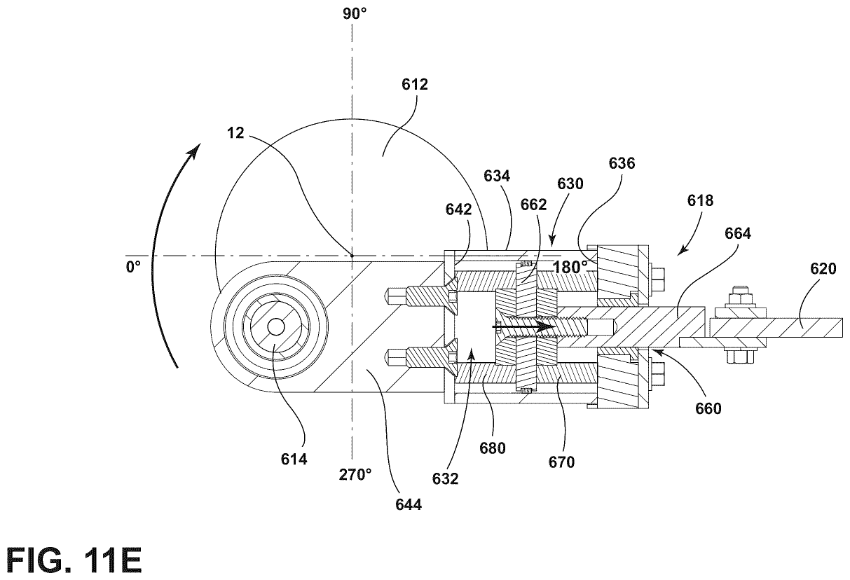

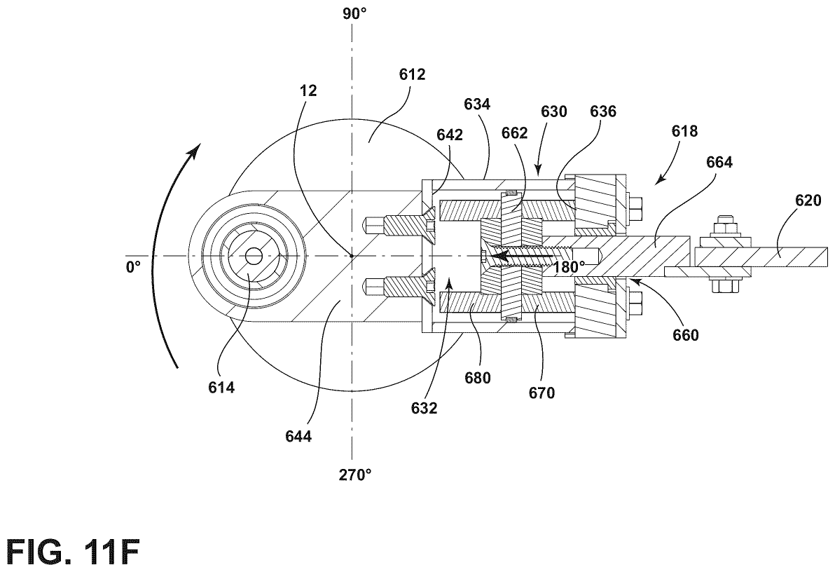

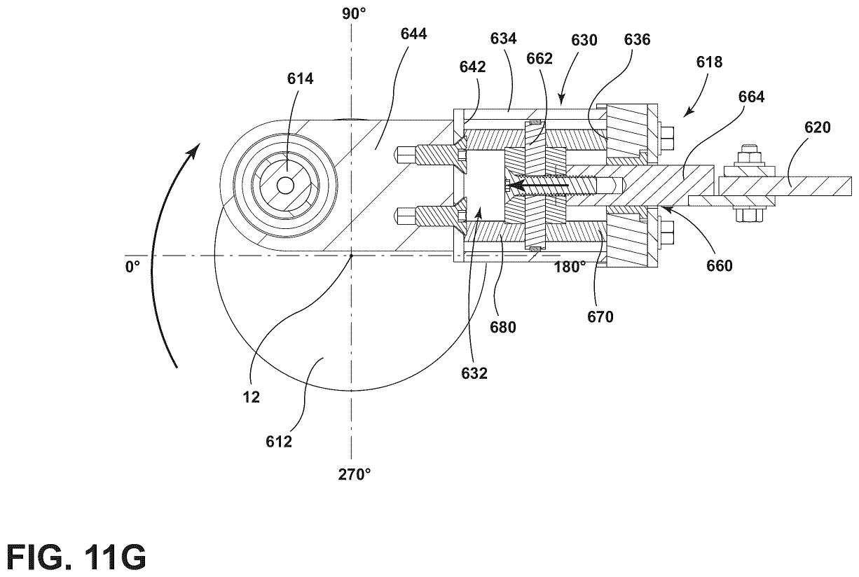

A second example of a conveyor system 10′ and a method of operating the second exemplary conveyor system 10′ is depicted in FIGS. 10A-11G. In contrast to the first exemplary conveyor system 10 depicted in FIGS. 1-9G where the conversion assembly 600 is partially and/or entirely disposed below and/or under the tray assembly 200, the conversion assembly 600 of the second exemplary conveyor system 10 is not disposed below and/or under the tray assembly 200. The second conveyor system 10′ is otherwise structured in the same and/or a similar manner as the first exemplary conveyor system 10 depicted in FIGS. 1-9G and is therefore not described in detail for brevity. The method of operating the second conveyor system 10′ depicted in FIGS. 10A-11G is also substantially similar to the method of operating the first conveyor system 10 described above except that the piston bumpers 670, 680 and the cylinder end walls 636, 642 referred to are reversed. For example, as the crank journal 614 rotates clockwise from the 45° position toward the 180° position, the first piston bumper 670 is compressed and the second piston bumper 680 is moved out of contact with the second end wall 642 in the first exemplary conveyor system 10 while, in the exemplary second conveyor system 10′, the second piston bumper 680 is compressed and the first piston bumper 670 is moved out of contact with the first end wall 636.

Other non-illustrated conveyor systems are also contemplated. For example, a conveyor system in which the conversion assembly 600 is partially and/or entirely disposed below and/or under the tray assembly 200 (e.g., similar to the first exemplary conveyor system 10 depicted in FIGS. 1-9G) may be configured to utilize a pushing type motion during operation (e.g., similar to that of the second conveyor system 10′ depicted in FIGS. 10A-11G). As another example, a conveyor system in which the conversion assembly 600 is not disposed below and/or under the tray assembly 200 (e.g., similar to the second conveyor system 10′ depicted in FIGS. 10A-11G) may be configured to utilize a pulling type motion during operation (e.g., similar to the first exemplary conveyor system 10 depicted in FIGS. 1-9G).

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A conveyor system, comprising:
a foundation;
a tray assembly moveably connected to and suspended from the foundation;
a motor assembly configured to move the tray assembly relative to the foundation; and
a conversion assembly connected to the motor assembly and to the tray assembly, the conversion assembly configured to convert rotary movement provided by the motor assembly into reciprocating movement of the tray assembly;
wherein the conversion assembly includes:
a transition plate connected to the motor assembly and rotatable about a rotation axis via the motor assembly, the transition plate including a crank journal arranged offset from the rotation axis; and
a connecting rod connected to the transition plate and to the tray assembly, the connecting rod including:
a cylinder pivotably connected to the crank journal of the transition plate such that the cylinder translates in a circular motion around the rotation axis via rotation of the transition plate; and
a piston including i) a piston rod connected to the tray assembly and ii) a piston head connected to the piston rod and adjustably arranged in a chamber of the cylinder.

2. The conveyor system of claim 1, wherein the connecting rod further includes at least one deformable piston bumper disposed in the chamber and compressible between the piston head and the cylinder.

3. The conveyor system of claim 1, wherein the piston further includes a first deformable piston bumper and a second deformable piston bumper disposed on opposite sides of the piston head.

4. The conveyor system of claim 3, wherein:
the first piston bumper is mounted on a first axial end of the piston head; and
the second piston bumper is mounted on an opposite second axial end of the piston head; and
the first piston bumper and the second piston bumper move within the chamber in conjunction with the piston head.

5. The conveyor system of claim 3, wherein:
the cylinder includes a cylindrical wall, a first end wall, and a second end wall that collectively define the chamber;
the first end wall and the second end wall are disposed at and connected to opposite axial ends of the cylindrical wall;
the first piston bumper is mounted on the first end wall of the cylinder and is compressible via a first axial end of the piston head; and
the second piston bumper is mounted on the second end wall of the cylinder and is compressible via an opposite second axial end of the piston head.

6. The conveyor system of claim 3, wherein:
the cylinder includes a cylindrical wall, a first end wall, and a second end wall that collectively define the chamber;
the first end wall and the second end wall are disposed at and connected to opposite axial ends of the cylindrical wall;
the first piston bumper is floatingly arranged between the first end wall of the cylinder and a first axial end of the piston head; and
the second piston bumper is disposed between the second end wall of the cylinder and an opposite second axial end of the piston head.

7. The conveyor system of claim 3, wherein the first piston bumper and/or the second piston bumper is a tube-shaped body and/or a ring-shaped body.

8. The conveyor system of claim 1, wherein the conversion assembly further includes a flexible belt connecting the connecting rod and the tray assembly to one another.

9. The conveyor system of claim 8, wherein the belt is connected to an end of the piston rod opposite the piston head and to a tray frame of the tray assembly.

10. The conveyor system of claim 1, wherein the foundation includes a foundation frame and at least one strap connector adjustably connecting the tray assembly to the foundation frame.

11. The conveyor system of claim 10, wherein the at least one strap connector includes:
a hanger connected to and projecting from the foundation frame; and
a strap having a first end attached to the hanger and an opposite second end attached to the tray assembly such that the tray assembly is suspended from the hanger via the strap.

12. The conveyor system of claim 10, wherein the foundation further includes at least one diverter disposed at least partially above and shielding the at least strap connector from falling material.

13. The conveyor system of claim 12, wherein the at least diverter is structured as a panel and is oriented at a downward angle toward the tray assembly such that falling material contacts the at least one diverter and is directed onto the tray assembly.

14. The conveyor system of claim 1, wherein the tray assembly includes a tray frame and at least one panel disposed on and connected to the tray frame.

15. The conveyor system of claim 14, wherein:
the foundation includes:
a plurality of first longitudinal members and a plurality of second cross members connected to one another to define a foundation frame; and
a plurality of strap connectors connected to and projecting from the plurality of first longitudinal members of the foundation frame;
the tray assembly further includes a plurality of second longitudinal members and a plurality of second cross members connected to one another to define the tray frame; and
each end of each of the plurality of second cross members of the tray frame is connected to the foundation frame via a respective strap connector of the plurality of strap connectors.

16. The conveyor system of claim 1, further comprising a plurality of adjustable mounting assemblies, wherein:
each adjustable mounting assembly of the plurality of adjustable mounting assemblies includes:
a mount plate securable to a supporting structure;
a slider plate adjustably connected to the mount plate; and
an adjustor via which the slider plate is adjustable relative to the mount plate;
at least a portion of the motor assembly is mounted on the slider plate of a first adjustable mounting assembly of the plurality of adjustable mounting assemblies;
at least a portion of the conversion assembly is mounted on the slider plate of a second adjustable mounting assembly of the plurality of adjustable mounting assemblies; and
the first adjustable mounting assembly and the second adjustable mounting assembly are arranged and oriented relative to one another such that the slider plate of the first adjustable mounting assembly and the slider plate of the second adjustable mounting assembly are adjustable parallelly to one another.

17. A conveyor system, comprising:
a tray assembly configured to receive and support material;
a foundation including a foundation frame and a plurality of strap connectors, the plurality of strap connectors each including:
a hanger connected to and projecting from the foundation frame; and
a strap having a first end attached to the hanger and an opposite second end attached to the tray assembly such that the tray assembly is suspended from the hanger via the strap;
a motor assembly configured to move the tray assembly relative to the foundation;
a conversion assembly connected to the motor assembly and to the tray assembly, the conversion assembly configured to convert rotary movement provided by the motor assembly into reciprocating movement of the tray assembly; and
wherein the foundation further includes a frame bumper connected to the foundation frame and into which the tray assembly moves into and out of contact with during the reciprocating movement of the tray assembly.

18. The conveyor system of claim 17, wherein the conversion assembly includes:
a transition plate connected to the motor assembly and rotatable about a rotation axis via the motor assembly, the transition plate including a crank journal arranged offset from the rotation axis; and
a connecting rod connected to the transition plate and to the tray assembly.

19. The conveyor system of claim 18, wherein the connecting rod includes:
a cylinder pivotably connected to the crank journal of the transition plate such that the cylinder translates in a circular motion around the rotation axis via rotation of the transition plate; and
a piston including:
a piston rod connected to the tray assembly; and
a piston head connected to the piston rod and adjustably arranged in a chamber of the cylinder.

20. The conveyor system of claim 19, wherein the connecting rod further includes at least one deformable piston bumper disposed in the chamber and compressible between the piston head and the cylinder.
